(19) United States
(12) Patent Application Publication
(10) Pub. No.: US 2013/0014403 A1
(43) Pub. Date: Jan. 17, 2013

(54) Dryer Load Chute

(71) Applicants: Ryan J. Blair, Syracuse, NY (US); Jeffrey R. Wolsley, North Syracuse, NY (US); Stephen D. Wilbur, East Freetown, NY (US); Joseph B. Gudenburr, IV, Manlius, NY (US)

(72) Inventors: Ryan J. Blair, Syracuse, NY (US); Jeffrey R. Wolsley, North Syracuse, NY (US); Stephen D. Wilbur, East Freetown, NY (US); Joseph B. Gudenburr, IV, Manlius, NY (US)

(73) Assignee: G.A. BRAUN, INC., North Syracuse, NY (US)

(21) Appl. No.: 13/549,171

(22) Filed: Jul. 13, 2012

Related U.S. Application Data
(60) Provisional application No. 61/507,446, filed on Jul. 13, 2011.

(51) Int. Cl. B65G 11/20; F26B 25/12; F26B 19/00

(52) U.S. Cl. 34/165; 193/2 R

(57) ABSTRACT

A chute for a laundry system having an inwardly tapered body extendng from an open top area towards a closed bottom end. The top edge of the chute is laterally spaced from the dryer unit and vertically spaced above the opening of the dryer's load door, while the bottom edge is connected to or abutting the dryer unit at a position vertically spaced just coincident with or below the load door. Side walls enclose the sides of the chute relative to the dryer. The door is equipped with a motor and mechanism for automatically opening and closing during loading and operation, respectively. The door may form the bottom trough portion of the chute. A programmable logic controller synchronizes the opening and closing of the door with the sling type rail system that drops the garments through the chute to eliminate the need for operator involvement with regard to the door.

### REFERENCE TO RELATED APPLICATION

The present application relates to and claims priority to Applicant's U.S. Provisional Patent Application, Ser. No. 61/507,446, filed Jul. 13, 2011, the entirety of which is hereby incorporated by reference.

### BACKGROUND

1. Field of Invention

The present invention relates generally to industrial laundry machines and more particularly to structure to assist in the loading of industrial dryer from a sling type rail system.

2. Background of Art

Sling type rail systems are used to carry large bags of garments upside down towards a dryer unit where they will be opened to allow the garments to fall by gravity into the dryer unit. For a front load dryer the operator of the laundry system must open the sling bag and push the garments into the dryer as they are falling, and while the conveyor is continuously moving. Due to the weight and bulk of the garments, it is a difficult process to ensure that the garments are all making their way into the dryer without falling to the floor. In addition, due to the continuous movement of the conveyor carrying the sling bags, the efficiency of the loading process is often adversely affected by the operator's inability to successfully push all the garments from one sling bag into the dryer in a timely manner. Finally, as the dryer is oftentimes tumbling while the garments are being pushed into the dryer, the operator's involvement of pushing the garments into the dryer presents the danger of the operator's hand or arm becoming caught up in the tumbling dryer causing injury to the operator.

### OBJECTS AND ADVANTAGES

It is a principal object and advantage of the present invention to provide a chute that directs garments from a sling bag directly into a dryer.

It is a further object and advantage of the present invention to provide a garment loading system that includes a chute and an automated door that opens and closes for loading or operation of the dryer, respectively.

It is another object and advantage of the present invention to provide a chute that synchronously communicates with the sling type load system and the door of the dryer.

It is a further object and advantage of the present invention to provide a chute that improves the efficiency and operation or a sling type load system.

Other objects and advantages of the present invention will in part be obvious and in part appear hereinafter.

### SUMMARY OF THE INVENTION

In accordance with the foregoing objects and advantages, the present invention provides a chute for an industrial laundry system that comprises an inwardly tapered body that extends from an open top area towards a closed bottom end. The top edge of the chute is laterally spaced from the dryer unit and vertically spaced above the opening of the dryer's load door, while the bottom edge is connected to or abutting the dryer unit at a position vertically spaced just below the load door. Side walls (triangular shaped in the preferred embodiment, but could be of any shape that facilitates enclosing the chute and directing garments into the dryer, such as trapezoidal, rectangular, for example) enclose the sides of the chute relative to the dryer. As the chute would prevent operator access to the dryer's door, the door is equipped with a motor and mechanism for automatically opening and closing the door during load and operation, respectively. A programmable logic controller synchronizes the opening and closing of the door with the sling type rail system that drops the garments through the chute to eliminate the need for operator involvement of the door.

In an alternate embodiment of the present invention the chute is mounted to the dryer for pivotal movement with respect thereto. Pneumatic or hydraulic pistons can be attached to the chute to move it into or out of loading position by pivoting about the lower edge of the chute. The movement of the chute can also be synchronized with the opening and closing of the load door via the PLC.

### BRIEF DESCRIPTION OF THE DRAWINGS

The present invention will be more fully understood and appreciated by reading the following detailed description in conjunction with the accompanying drawings, in which:

FIG. 1 is a perspective view of the dryer and chute of the present invention;

FIG. 2 is a side elevation view thereof;

FIG. 3 is a side elevation view thereof;

FIG. 4 is a perspective view of an alternate embodiment of the present invention that includes a pivotally mounted loading chute;

FIGS. 5A and 5B are perspective views of a third alternate embodiment of the present invention of the chute in closed and open positions, respectively, with FIG. 5B being an enlarged view of a section of the invention;

FIGS. 6A and 6B are front elevation views thereof with the chute in closed and open positions, respectively;

FIGS. 7A and 7B are side elevation views thereof with the chute in closed and open positions, respectively; and

FIGS. 8A and 8B are top plan views thereof with the chute in closed and open positions, respectively.

### DETAILED DESCRIPTION

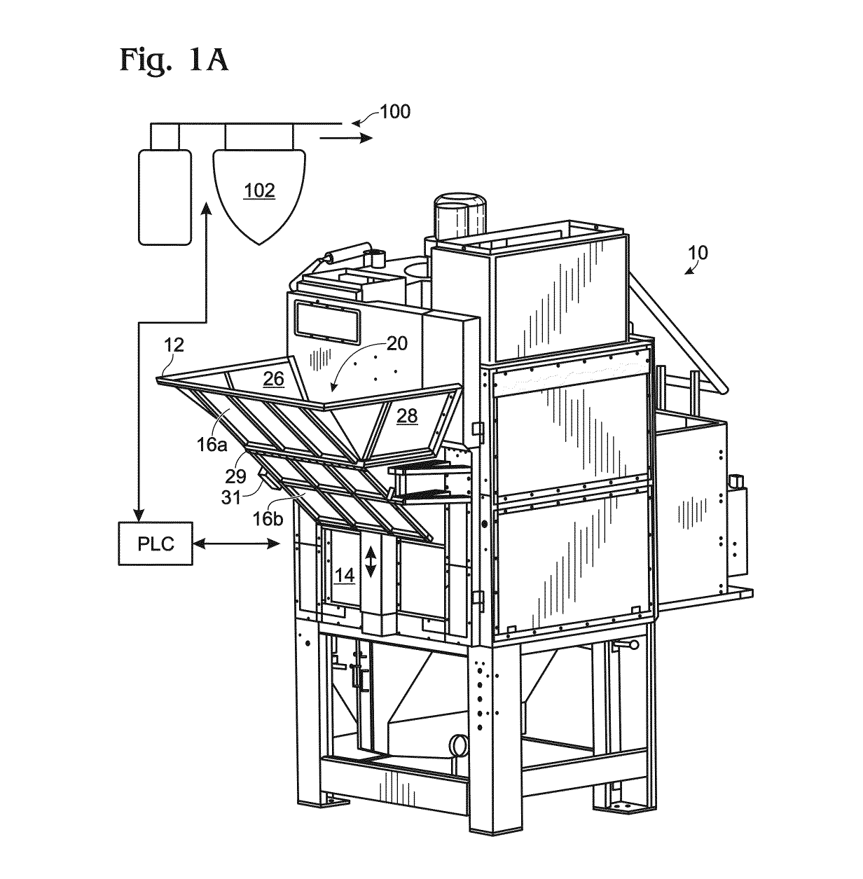

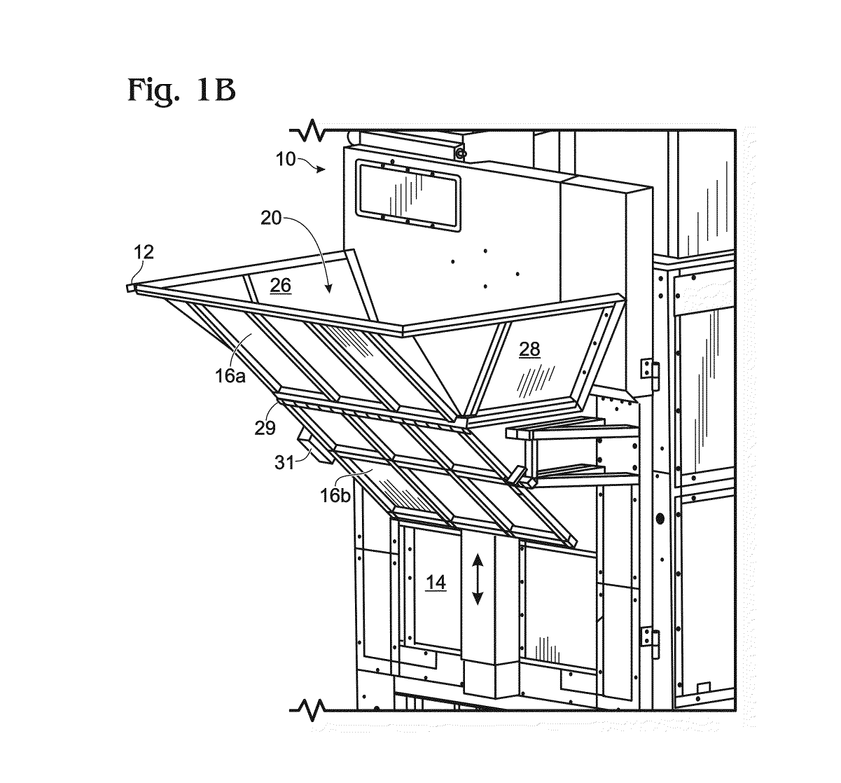

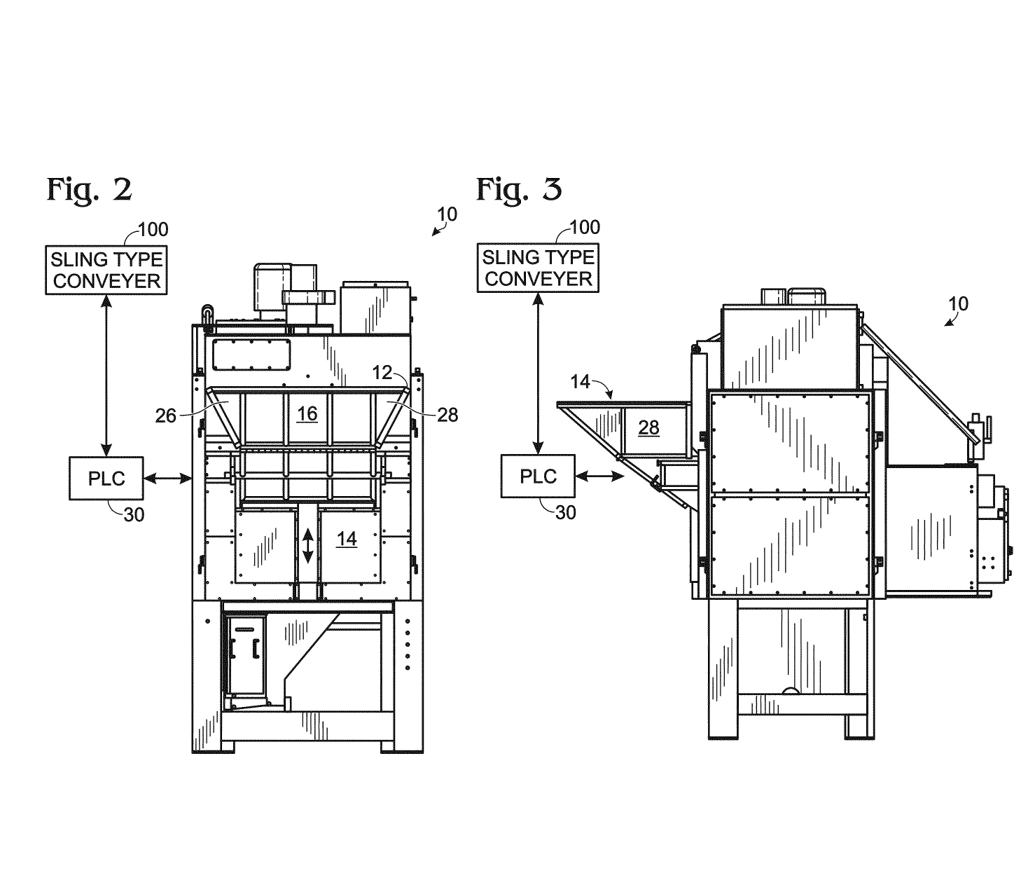

Referring now to the drawings, wherein like reference numerals refer to like parts throughout, there is seen in FIG. 1 an industrial laundry dryer, designated generally by reference numeral 10, comprising a loading chute 12 and a load door 14 located on the front of the dryer. Dryer 10 is used in combination with a conventional automated sling type conveyor system, designated generally by reference numeral 100, which carries sling bags 102 that are filled with garments to be deposited into dryer 10.

In one embodiment, chute 12 comprises a downwardly sloping front wall 16 (comprised of upper and lower halves 16a and 16b, respectively) having an upper edge 18 positioned in vertically spaced relation above the opening 20 of door 14, a lower edge 22 attached in abutting relation to the front frame 24 of dryer 10 in vertically spaced relation below opening 20, and a pair sidewalls 26, 28 that enclose chute 12 with respect to dryer 10. Sidewalls 26, 28 are triangular in shape in the preferred embodiment disclosed, but it should be understood that other shapes are also feasible (e.g., trapezoidal, rectangular, etc.) As garments fall out of bag 102 (via an operator untying or otherwise opening bag 102), they will be funneled by chute 12 through the opening 20 of door 14 into dryer 10.

Front wall upper and lower halves 16a and 16b, respectively, are connected to one another by a hinge 29 that permits lower half 16b to pivotally move away from dryer 10. A rod 31 extends across the exterior surface of half 16b to lock it in its closed position, but upon release of the rod, half 16b will pivot away from dryer 10. This pivotal movement of bottom half 16b permits an operator to unclog the chute in the event garments do get clogged by removing rod 31 and allowing the garments to fall to the floor.

Door 14 is automatically opened and closed when bags 102 are positioned for unloading into dryer 10 by a programmable logic controller (PLC) 30 that provides signals to a motor that drives a mechanism to slide door 14 within rails positioned within frame 24 in a vertical plane into and out of covering relation with opening 20. When door 14 is closed, dryer 10 can be operated, whereas while door 14 is open, dryer 10 can be loaded.

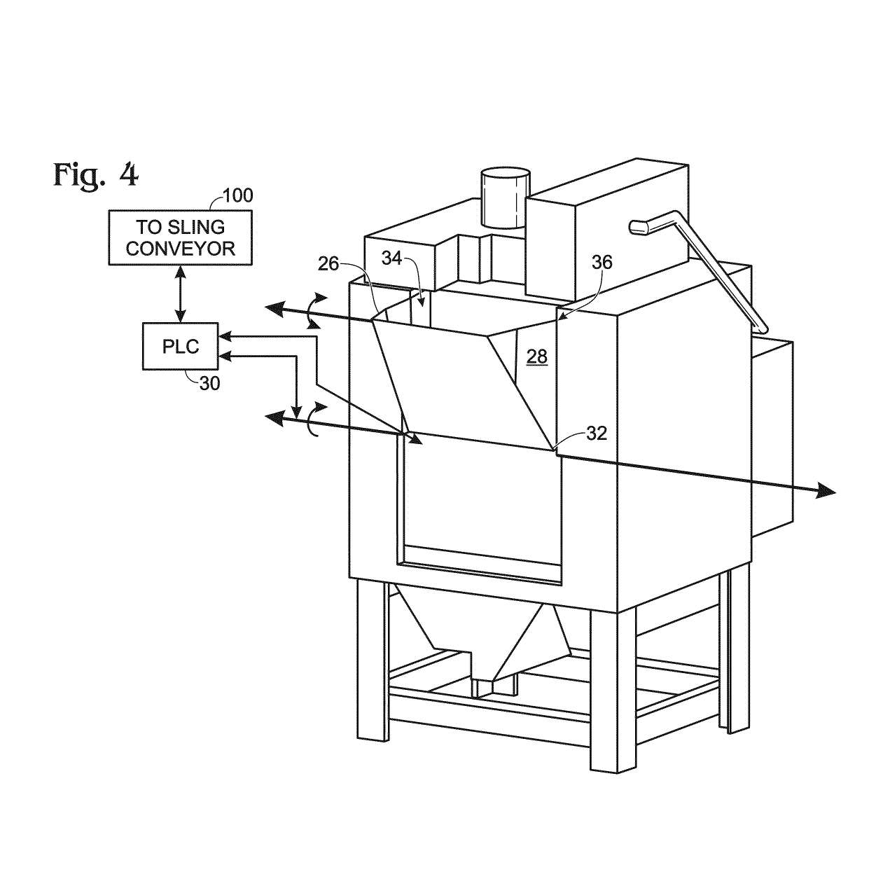

With reference to FIG. 4, chute 12 can be mounted with its lower edge 16 attached to a rod 32 that will rotate by means of a hydraulic or pneumatic piston. Sidewalls 26 and 28 can slide into and out of a slotted recess 34 and 36, respectively, in front frame 24 to permit the pivotal movement of chute 12. PLC 30 provides signals to synchronize the unloading of bags 102 through the opening 26 (i.e., door 14 will be moved to its open position), and chute 12 to its load position. Likewise, PLC 30 will provide signals to synchronize the pivotal closing of chute 12, closing of door 14 and non-loading position of sling system 100.

Although optional, the conventional blower mounted on dryer 10 can be activated during the load operation to assist in pulling the garments into dryer 10. The blower can be actuated by the PLC 30 simultaneously with the opening of door 14.

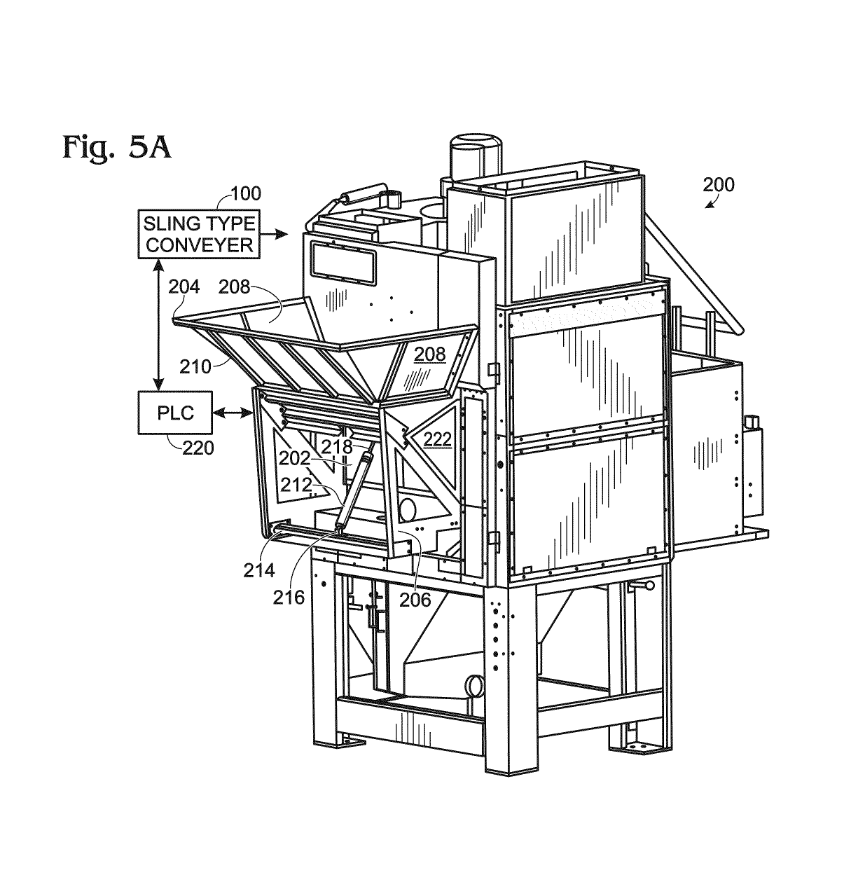

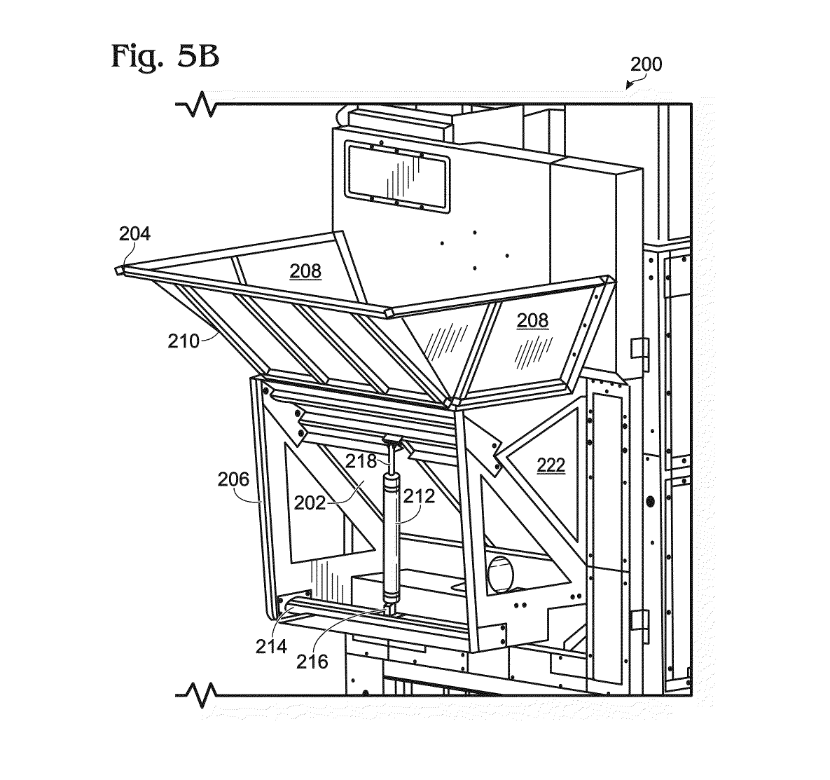

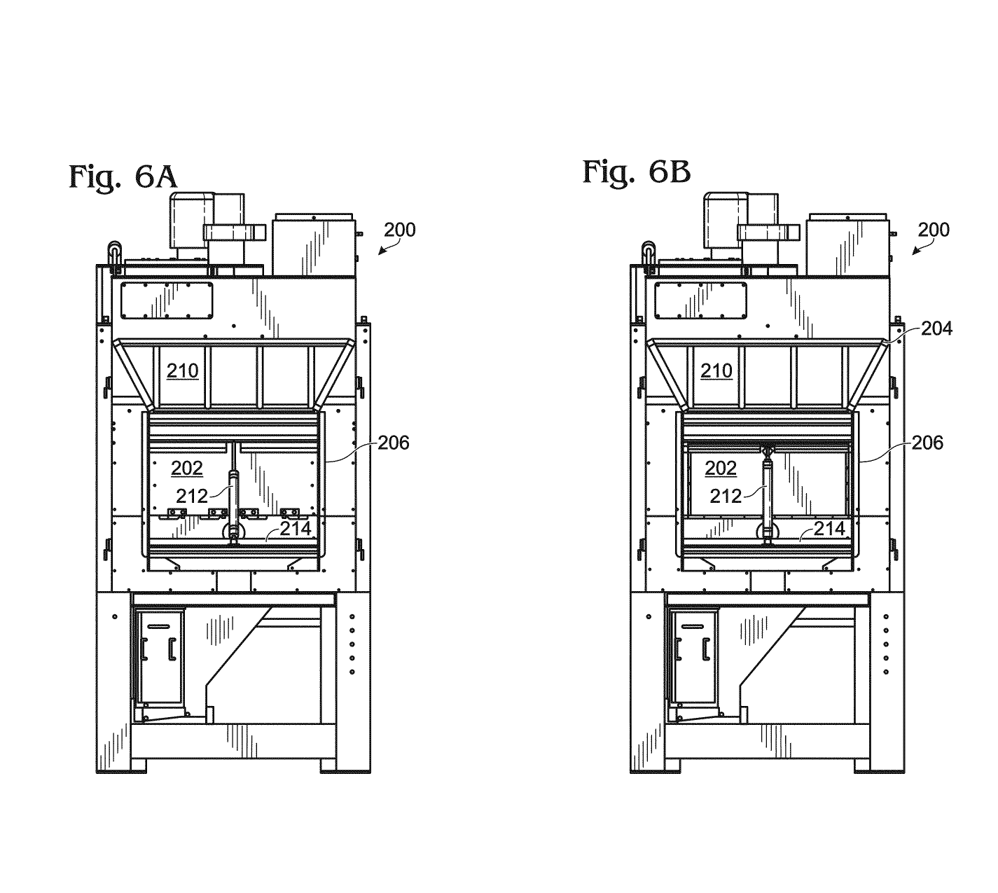

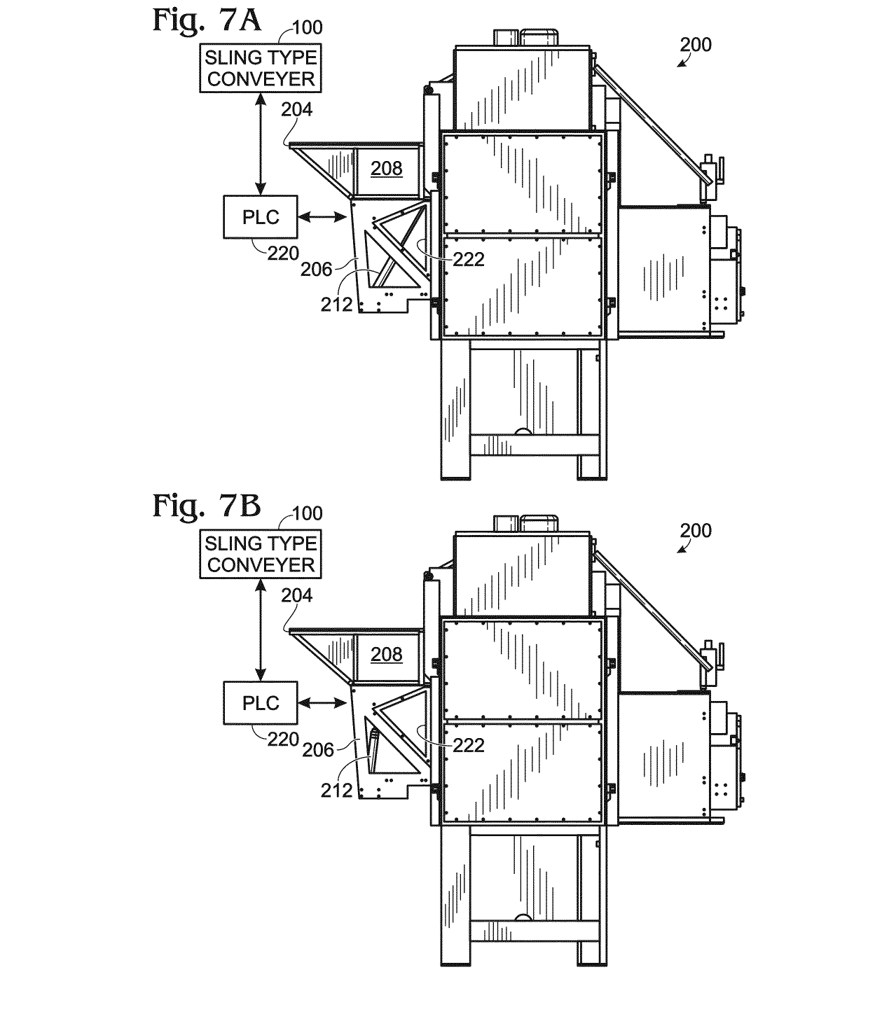

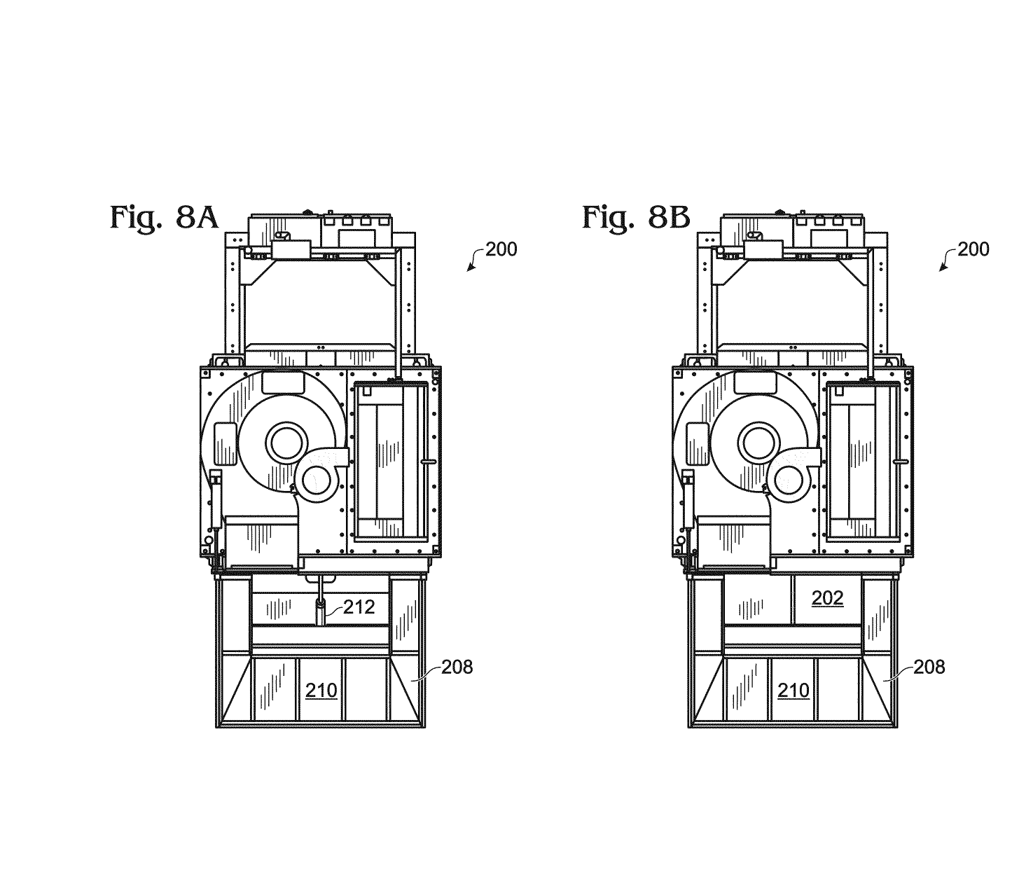

In another embodiment of the present invention as illustrated in FIGS. 5-8, dryer 200 is provided with a load door 202 that is pivotally movable about its hinged lower edge between open and closed positions and forms the bottom part of the load chute 204 when in its open position. More specifically, chute 204 comprises an underlying support frame 206 on top of which the sidewalls 208 and front wall 210 of the chute are mounted. A cylinder 212 (air driven in the preferred embodiment, but any conventional cylinder could be used) is mounted at its bottom end to a horizontally extending cross-bar 214 of frame 206 by a yoke 216 that permits the cylinder to pivot about the horizontal axis that is parallel to cross-bar 214. The exterior end of the piston 218 (that reciprocally moves within cylinder 212) is attached to load door 202. Upon actuation, piston 218 will move within cylinder 212 to pull open or push closed door 202.

As with the other embodiments, a PLC 220 is programmed to synchronously provide actuation signals to cylinder 212 upon appropriate placement of a sling bag above chute 204. When a sling bag arrives above chute 204, PLC 220 will send a signal to cylinder 212 that causes it to pull door 202 open, and when the bag is empty, PLC 220 will send a signal causing door 202 to close. When door 202 is opened, it extends between dryer 200, sidewalls 208 and the front wall 210 to form the bottom trough portion of chute 204, as seen in FIGS. 5B, 6b, 7B, and 8B. When door 202 closes, it will push any garments that remain on the door's interior surface into the dryer.

A window 222 is provided in the side of frame 206 and is held in place by a series of bolts or other fasteners. In the event chute 204 becomes clogged, an operator can remove the bolts/fasteners to gain access to the garments through the window 222, and then reconnect the window once the clog has been cleared.

What is claimed is:

1. A system for directing gravity-fed garments dispensed from a sling bag a towards and through the door of a dryer, comprising:
A. a chute having a bottom end that is attached to the dryer in vertically spaced relation below the door, a front panel that extends upwardly from said bottom end to a top edge that is spaced laterally from the dryer and in vertically spaced relation above the door, and first and second side walls that are respectively attached along one edge to the dryer on opposing sides of the door and at their respective opposite edges to said front panel, and along their respective bottom edges to said bottom end;
B. a motor operatively connected to the door and adapted to provide motive force to open and close the door relative to the dryer; and
C. a programmable logic controller programmed to provide a signal to said motor for purposes of causing said motor to move the door between its open and closed positions.

2. The system of claim 1, wherein said bottom edge comprises the bottom edge of said front panel.

3. The system of claim 2, further comprising an elongated rod having a longitudinal axis and attached to said bottom edge of said front panel.

4. The system of claim 3, further comprising a piston attached to said rod, said piston being actuable to cause rotation of said rod about its longitudinal axis, whereby the rotation of said rod causes pivotal movement of said chute towards and away from the door of the dryer.

5. An industrial dryer for use in combination with a ling type conveyor system that gravity feeds garments towards the dryer, comprising:
A. a door movable between open and closed positions and that provides access to the interior of the dryer;
B. a chute attached to the dryer and having a body that is formed to funnel garments towards said door; and
C. a programmable logic controller that is programmed to open and close said door.

6. The industrial dryer according to claim 5, further comprising a piston and cylinder wherein said piston is attached to said door and is movable in response to a signal provided by said programmable logic controller.

7. The industrial dryer according to claim 5, wherein said door comprises first and second halves hingedly connected to one another.

8. The industrial dryer according to claim 7, further comprising a rod that extends across said second half of said door and is selectively movable into and out of engagement with said second half of said door.

9. The industrial dryer according to claim 5, wherein said door includes a lower edge hingedly connected to the dryer.

10. The industrial dryer according to claim 9, further comprising a piston and cylinder arrangement, wherein said piston is attached to said door and said cylinder is securely mounted for pivotal movement about a horizontal axis, whereby actuation of said piston moves said door between open and closed positions.
